(19) United States
(12) Patent Application Publication
(10) Pub. No.: US 2012/0067972 A1
(43) Pub. Date: Mar. 22, 2012

(54) SPRAYING UNIT

(75) Inventor: Harald Schliemann, Waiblingen (DE)

(73) Assignee: ANDREAS STIHL AG & CO. KG

(21) Appl. No.: 13/228,720

(22) Filed: Sep. 9, 2011

(30) Foreign Application Priority Data
Sep. 16, 2010 (DE) 10 2010 045 708.6

(51) Int. Cl. B05B 7/24

(52) U.S. Cl. 239/152

(57) ABSTRACT

A spraying unit has a drive engine for driving a blower, has a blow pipe through which an air flow is conveyed by the blower, and has a spraying agent tank which is arranged on a backpack of the spraying unit. A nozzle is provided which is connected via the spraying agent line to the spraying agent tank and which supplies spraying agent to the air flow. To obtain the same spraying agent discharge in almost any position of the blow pipe, it is provided that a pressure regulator is arranged in the spraying agent line upstream of the nozzle.

### CROSS-REFERENCE TO RELATED PATENT APPLICATIONS

This application is based upon and claims the benefit of priority from prior German Patent Application No. 10 2010 045 708.6, filed Sep. 16, 2010, the entire contents of which are incorporated herein by reference in their entirety.

### BACKGROUND

The invention relates to a spraying unit of the generic type specified in the preamble of Claim 1.

WO 2010/008374 A1 discloses a backpack-type blowing unit in which spraying agent is dosed to the air flow owing to the negative pressure generated at the nozzle. The negative pressure generated at the nozzle is dependent firstly on the rotational speed of the engine and secondly on the height at which the nozzle is arranged in relation to the spraying agent tank. During operation, the user may spray both downwards and upwards. The vertical pivoting movement of the blow pipe results in a variation in the height difference between the nozzle and the spraying agent tank and therefore a change in the hydrostatic pressure at the nozzle, which has a considerable influence on the amount of spraying agent supplied.

It is also known for the spraying agent to be delivered into the blow pipe by means of a pump. This however makes the design of the spraying unit more complex, and the weight of the spraying unit is increased on account of the additional parts.

### SUMMARY OF PREFERRED EMBODIMENTS

The invention is based on the object of providing a spraying unit of the generic type which is of simple construction and which ensures a uniform discharge of spraying agent.

Said object is achieved by means of a spraying unit having the features of Claim 1.

The pressure variations arising owing to the different working heights of the blow pipe as it is being pivoted during operation can be compensated by means of the pressure regulator in the spraying agent line. The pressure regulator supplies the spraying agent at constant pressure to the nozzle. A separate pump is not required. The spraying agent can be dosed on the basis only of the negative pressure at the outlet nozzle and the geodetic pressure difference between the spraying agent tank and the nozzle.

The air flow advantageously exits the blow pipe through an outlet opening. The pressure regulator and the nozzle are in particular arranged on the blow pipe adjacent to the outlet opening. Since pressure regulator and nozzle are arranged directly adjacent to one another, the pressure difference on account of the height difference between the pressure regulator and the nozzle is minimal. The arrangement of the nozzle adjacent to the outlet opening results in a good discharge of spraying agent.

A dosing device for spraying agent is advantageously arranged in the spraying agent line between the pressure regulator and the nozzle. The pressure regulator is accordingly arranged upstream of the dosing device. The dosing device is advantageously arranged directly adjacent to the nozzle.

The pressure regulator advantageously has a deactivation position. In this way, it is possible for the container to be emptied via the dosing device. In its operational position, the pressure regulator would block the flow through the pressure regulator on account of the pressure conditions, such that an emptying of the spraying agent container would not be possible. The pressure regulator is advantageously designed as a diaphragm regulator. The pressure regulator has in particular a regulating chamber, a regulating diaphragm which delimits the regulating chamber, and an inlet valve into the regulating chamber, the position of which inlet valve is coupled to the position of the regulating diaphragm. Here, the inlet valve is advantageously spring-loaded in its closing direction. It may be provided that that side of the regulating diaphragm which faces away from the regulating chamber is acted on by ambient air. That side of the regulating diaphragm which faces away from the regulating chamber is particularly advantageously connected to the interior space of the spraying agent tank. In this way, the pressure in the interior of the spraying agent tank serves as a reference pressure. This is advantageous in particular if the spraying agent tank is pressurized and the pressure in the spraying agent tank differs from the ambient pressure.

A simple design is obtained if the pressure regulator has a control element which, in a deactivation position, deflects the regulating diaphragm and thereby opens the inlet valve. The regulating diaphragm is accordingly pressed into the open position of the inlet valve by the control element regardless of the prevailing pressure conditions.

To obtain a good delivery of spraying agent, it is provided that the spraying agent tank is pressurized. This may be achieved in a simple manner by virtue of the spraying agent tank being connected via a pressure line to a positive pressure region of the blower. The blower advantageously has a blower impeller which is arranged in a blower spiral. The pressure line opens in particular into a positive pressure region of the blower spiral.

During work breaks, the operator releases the throttle lever, such that the rotational speed of the drive engine and of the blower impeller falls. As a result, only a small positive pressure is generated in the blower spiral. Therefore, the pressure in the spraying agent tank also falls very drastically. If the operator operates the throttle lever again, the pressure in the spraying agent tank must initially be built up again. To reduce this time delay, a check valve which opens towards the spraying agent tank may be arranged in the pressure line. The pressure build-up in the spraying agent tank is thereby reduced.

A simple structural design is obtained if the pressure regulator is fixed to the blow pipe by means of a fastening clip which engages at least partially around the blow pipe. A pressure regulator designed in this way may thus also be retrofitted in a simple manner to existing spraying units.

### BRIEF DESCRIPTION OF THE DRAWINGS

Exemplary embodiments of the invention will be explained below on the basis of the drawing, in which:

FIG. 1 shows a side view of a spraying unit,

FIGS. 2 and 3 show schematic illustrations of the spraying agent line and pressure lines of spraying units,

FIG. 4 shows a perspective illustration of a pressure regulator,

FIG. 5 shows a plan view of the pressure regulator from FIG. 4,

FIG. 6 shows a section along the line VI-VI in FIG. 5,

FIG. 7 shows a section along the line VII-VII in FIG. 5, and

FIG. 8 shows a sectional illustration of the pressure regulator according to the line VI-VI in FIG. 5 when the pressure regulator is in the deactivation position.

### DETAILED DESCRIPTION OF PREFERRED EMBODIMENTS

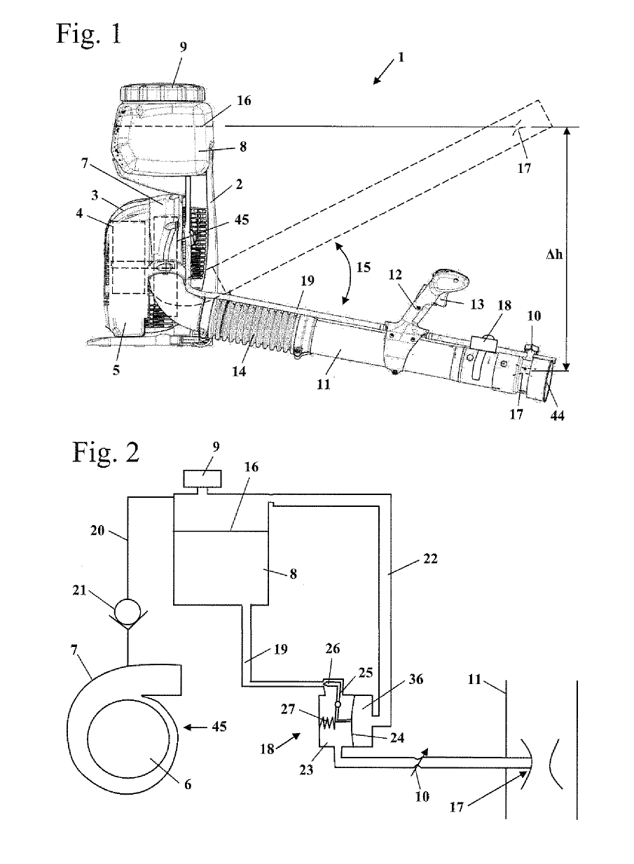

FIG. 1 shows a backpack-type spraying unit 1. The spraying unit 1 has a backpack 2 to which are fastened shoulder straps (not shown) by means of which the backpack 2 can be worn on the back of the user. Fixed to the backpack 2 is a housing 3 in which is arranged a drive engine 4 which drives a blower 45. The drive engine 4 is designed as a combustion engine, in particular as a two-stroke engine or as a mixture-lubricated four-stroke engine. Arranged below the combustion engine 4 is a fuel tank 5 which may be integrated into the housing 3 or formed as a separate housing part. A spraying agent tank 8 is fixed to the backpack 2 above the housing 3. The spraying agent tank 8 is filled with liquid spraying agent up to a filling level 16. The spraying agent tank 8 is closed off by a tank cover 9.

The blower 45 has a blower spiral 7 which is integrated in the housing 3 and to which a blow pipe 11 is connected. Fixed to the blow pipe 11 is a handle 12 on which is arranged a throttle lever 13 for controlling the drive engine 4. The blow pipe 11 has a bellows section 14 such that the blow pipe 11 can be pivoted during operation, as is schematically indicated by the arrow 15. The blower 45 delivers an air flow through the blow pipe 11, which air flow exits the blow pipe 11 through an outlet opening 44. Arranged in the blow pipe 11 upstream of the outlet opening 44 and a short distance from the outlet opening 44 is a nozzle 17. The nozzle 17 is connected via a spraying agent line 19 to the interior space of the spraying agent tank 8. Arranged adjacent to the nozzle 17 is a dosing device 10 which can be manually adjusted by the operator. A pressure regulator 18 is arranged in the spraying agent line 19 upstream of the dosing device 10 and directly adjacent to the dosing device 10 and to the outlet opening 44, the function of which spraying agent line 19 will be explained in more detail below. The filling level 16 has a height difference Δh in relation to the nozzle 17 in the blow pipe position shown. This results in a pressure difference of the spraying agent between the spraying agent tank 8 and the nozzle 17. If the blow pipe 11 is moved into the upper position shown by dashed lines in FIG. 11, the nozzle 17 is situated approximately at the filling level 16, such that the hydrostatic pressure at the nozzle 17 corresponds to the pressure in the spraying agent tank 8. The pressure at the nozzle 17 is considerably lower than when the blow pipe 11 is in the lower position.

FIG. 2 schematically shows the design and the function of the pressure regulator 18. The pressure regulator 18 is arranged in the spraying agent line 19 and has a regulating chamber 23 into which the spraying agent line 19 opens from the spraying agent tank 8 via an inlet valve 26. The inlet valve 26 is arranged on a lever 25 which is loaded by a spring 27 in the direction of the closed position of the inlet valve 26. The lever 25 bears, with its side facing away from the inlet valve 26, against a regulating diaphragm 24. The regulating diaphragm 24 delimits the regulating chamber 23 and separates the latter from a compensation chamber 36. The reference pressure of the pressure regulator 18 prevails in the compensation chamber 36. In the exemplary embodiment, the compensation chamber 36 is connected via a compensation line 22 to the interior space of the spraying agent tank 8, such that the same pressure prevails in the compensation chamber 36 as prevails in the spraying agent tank 8.

The spraying agent tank 8 is advantageously pressurized. For this purpose, the pressure line 20 shown in FIG. 2 is provided which opens into a positive pressure region of the blower spiral 7. As is also shown in FIG. 2, the blower 45 comprises a blower impeller 6 which is driven in rotation and which is arranged in the blower spiral 7. The blower impeller 6 is designed as a fan impeller and delivers the working air through the blow pipe 11. A check valve 21 is arranged in the pressure line 20, which check valve opens in the direction of the spraying agent tank 8. In the event of a pressure drop in the blower spiral 7, for example if the operator releases the throttle, the pressure in the spraying agent tank 8 is substantially maintained, such that when the throttle is applied again, a positive pressure already prevails in the spraying agent tank 8 and need not be built up first. During operation, an approximately constant pressure prevails in the region of the spraying agent line 19 downstream of the pressure regulator 18. The magnitude of the pressure is structurally predefined by the design of the pressure regulator 18, for example the design of the spring 27. In a wide range of positions of the blow pipe 11, therefore, the amount of spraying agent dosed to the blow pipe 11 is dependent only on the air flow, that is to say on the rotational speed of the drive engine 4. Only when the nozzle 17 is arranged above the filling level 16 in the case of an unpressurized spraying agent tank 8, or arranged a considerable distance above the filling level 16 in the case of a pressurized spraying agent tank 8, does the pressure in the spraying agent line 19 downstream of the pressure regulator 18 fall because, even with the pressure regulator 18 fully open, the pressure level can no longer be compensated.

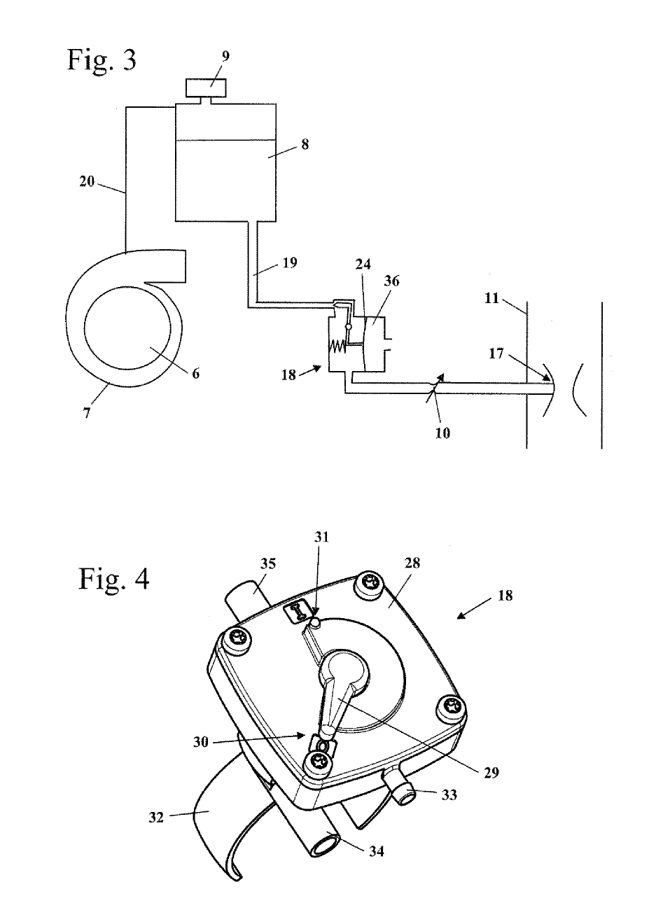

FIG. 3 shows an exemplary embodiment which corresponds substantially to that in FIG. 2. In the exemplary embodiment of FIG. 3, however, the compensation chamber 36 opens into the environment and not into the spraying agent tank 8. In the exemplary embodiment of FIG. 3, no check valve 21 is arranged in the pressure line 20, such that the pressure in the spraying agent tank 8 is quickly dissipated when the operator releases the throttle. It may also be provided that the spraying agent tank 8 is unpressurized, such that the pressure line 20 may also be omitted.

FIG. 4 shows the design of the pressure regulator 18 in detail. The pressure regulator 18 has a regulator housing 28, on the outside of which is arranged a control element 29 designed as a pivoting lever. The control lever 29 can be pivoted between a deactivation position 30 of the pressure regulator 18 and an operational position 31 of the pressure regulator 18. Intermediate positions in which the operation of the regulator is restricted may also be advantageous. An inlet port 34 and a compensation port 33 open into the regulator housing 28. Furthermore, an outlet port 35 leads out of the regulator housing 28. A fastening clip 32 is integrally formed on the regulator housing 28 on the side facing away from the control element 29, by means of which fastening clip the pressure regulator 18 can be clamped to the blow pipe 11 without additional fastening elements. The fastening clip 32 fixes the regulator housing 28 to the blow pipe 11 owing to the inherent elasticity of the plastic of the regulator housing 28. The fastening clip 32 shown in FIG. 4 has an opening via which the fastening clip 32 can be pushed over the blow pipe 11. The fastening clip 32 engages only partially around the blow pipe 11.

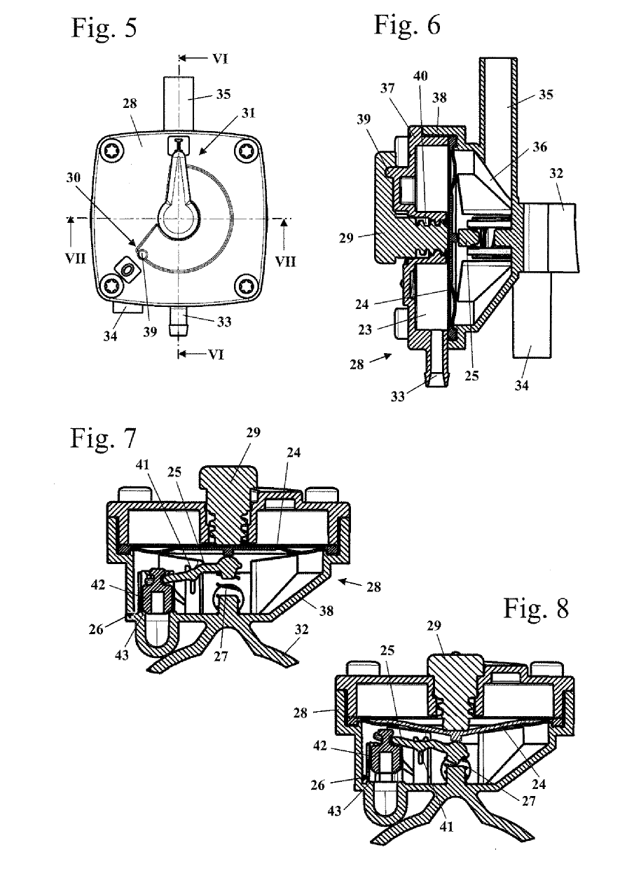

As is shown in FIG. 5, a latching peg 39 is integrally formed on the regulator housing 28 in order to define the deactivation position 30 of the control element 29.

As is shown in the sectional illustration in FIG. 6, a corresponding latching peg 39 is provided for the operational position 31. In the respective position, the control element 29 lies over the latching peg 39 and engages over the latter in order to define the latching position. As is also shown in FIG. 6, the regulator housing 28 has an upper housing shell 37, on which the control element 29 is arranged, and also a lower housing shell 38, on which the inlet port 34 and the outlet port 35 are formed. The regulating chamber 23 is formed in the upper housing shell 37, and the compensation chamber 36 is formed in the lower housing shell 38. The regulating diaphragm 24 is held clamped between the two housing shells 37 and 38. The two housing shells 37 and 38 are screwed to one another. The control element 29 is held in the upper housing shell 37 by means of a thread 40. In the deactivation position 31 shown in FIG. 6, the regulating diaphragm 24 bears, in the unloaded state of the pressure regulator 18, against the control element 29 and is not deflected. The lever 25 is arranged on the regulating diaphragm 24 at the side opposite the control element 29.

As is shown in FIG. 7, the lever 25 is pivotably mounted on a pivot bearing 41 in the housing 28. Fixed to the lever 25 at the end facing away from the regulating diaphragm 24 is a valve body 42 which, in the closed position, presses against a valve seat 43 and, together with the latter, forms the inlet valve 26. The spring 27 is arranged between the lever 25 and the lower housing shell 38. The spring 27 is arranged on the lever 25 opposite the control element 29.

As is shown in FIG. 8, in the deactivation position 30, the control element 29 is screwed further into the regulator housing 28. In said position, the control element 29 deflects the regulating diaphragm 24. As a result, the lever 25 is pivoted and the valve body 42 is raised from the valve seat 43. In said position, the inlet valve 26 is open, such that spraying agent can flow unhindered through the pressure regulator 18.

List of reference symbols

| | |
|---|---|
| 1 | Spraying unit |
| 2 | Backpack |
| 3 | Housing |
| 4 | Drive engine |
| 5 | Fuel tank |
| 6 | Blower impeller |
| 7 | Blower spiral |
| 8 | Spraying agent tank |
| 9 | Tank cover |
| 10 | Dosing device |
| 11 | Blow pipe |
| 12 | Handle |
| 13 | Throttle lever |
| 14 | Bellows section of 11 |
| 15 | Arrow |
| 16 | Filling level in 8 |
| 17 | Nozzle |
| 18 | Pressure regulator |
| 19 | Spraying agent line |
| 20 | Pressure line |
| 21 | Check valve in 20 |
| 22 | Compensation line |
| 23 | Regulating chamber |
| 24 | Regulating diaphragm |
| 25 | Lever |
| 26 | Inlet valve |
| 27 | Spring |
| 28 | Regulator housing |
| 29 | Control element |
| 30 | Deactivation position |
| 31 | Operational position |
| 32 | Fastening clip |
| 33 | Compensation port |
| 34 | Inlet port |
| 35 | Outlet port |
| 36 | Compensation chamber |
| 37 | Upper housing shell of 28 |
| 38 | Lower housing shell of 28 |
| 39 | Latching peg |
| 40 | Thread on 29 |
| 41 | Pivot bearing of 25 |
| 42 | Valve body |
| 43 | Valve seat |
| 44 | Outlet opening |
| 45 | Blower |
| Δh | Height difference |

1. Spraying unit having a drive engine for driving a blower, having a blow pipe through which an air flow is conveyed by the blower, having a spraying agent tank which is arranged on a backpack, and having a nozzle which is connected via a spraying agent line to the spraying agent tank and which supplies spraying agent to the air flow,
wherein a pressure regulator is arranged in the spraying agent line upstream of the nozzle.

2. Spraying unit according to claim 1,
wherein the air flow exits the blow pipe through an outlet opening and in that the pressure regulator and the nozzle are arranged on the blow pipe adjacent to the outlet opening.

3. Spraying unit according to claim 1,
wherein a dosing device for spraying agent is provided, which dosing device is arranged in the spraying agent line between the pressure regulator and the nozzle.

4. Spraying unit according to claim 1,
wherein the pressure regulator has a deactivation position.

5. Spraying unit according to claim 1,
wherein the pressure regulator has a regulating chamber, a regulating diaphragm which delimits the regulating chamber, and an inlet valve into the regulating chamber, wherein the position of the inlet valve is coupled to the position of the regulating diaphragm.

6. Spraying unit according to claim 5,
wherein the inlet valve is spring-loaded in its closing direction.

7. Spraying unit according to claim 5,
wherein that side of the regulating diaphragm which faces away from the regulating chamber is acted on by ambient pressure.

8. Spraying unit according to claim 5,
wherein that side of the regulating diaphragm which faces away from the regulating chamber is connected to the interior space of the spraying agent tank.

9. Spraying unit according to claim 5,
wherein the pressure regulator has a control element which, in a deactivation position, deflects the regulating diaphragm and thereby opens the inlet valve.

10. Spraying unit according to claim 1,
wherein the spraying agent tank is pressurized.

11. Spraying unit according to claim 10,
wherein the spraying agent tank is connected via a pressure line to a positive pressure region of the blower.

12. Spraying unit according to claim 11,
wherein the blower has a blower impeller which is arranged in a blower spiral, wherein the pressure line opens into the blower spiral.

13. Spraying unit according to claim 11,
wherein a check valve which opens towards the spraying agent tank is arranged in the pressure line.

14. Spraying unit according to claim 1,
wherein the pressure regulator is fixed to the blow pipe by means of a fastening clip which engages at least partially around the blow pipe.
